(19) United States
(12) Patent Application Publication
(10) Pub. No.: US 2017/0192942 A1
(43) Pub. Date: Jul. 6, 2017

(54) HIERARCHICAL POSITIONED EVENT DISPATCH

(71) Applicant: Google Inc., Mountain View, CA (US)

(72) Inventors: Christopher Craik, Mountain View, CA (US); Adam William Powell, Los Altos, CA (US)

(21) Appl. No.: 14/989,087

(22) Filed: Jan. 6, 2016

(51) Int. Cl. G06F 17/22; G06F 3/0488

(52) U.S. Cl. CPC G06F 17/2241; G06F 3/0488

(57) ABSTRACT

An electronic device (102) includes a display (104) to display a layout (108) of views, a user input component (212, 214, 216) to receive input representative of a positioned event (118), and a positioned event handler component (226) to detect the positioned event. The electronic device further includes a registry management component (230) to identify a terminal view (122) of the layout of views based on a location of the positioned event and a view tree management component (228) to construct an ancestor chain (126) of one or more ancestor views of the terminal view from the layout. The positioned event handler component is to sequentially dispatch the positioned event in the ancestor chain starting at a root view (110) of the ancestor chain.

### BACKGROUND

Field of the Disclosure

The present disclosure relates generally to graphical user interfaces and, more particularly, to receiving and processing touch events and other positioned events in a graphical user interface.

Description of the Related Art

Graphical user interfaces (GUIs) enable the use of multiple windows, or views, by which information may be displayed to a user or by which input may be received from a user. Often, this input is provided through the use of a touchscreen, trackpad, mouse, or other positional input component. In a conventional system, the user's interaction with the GUI via a positional input component takes the form of one or more positioned events, each having a two-dimensional location relative to the display space of the system. For each of these positioned events, the underlying GUI framework operates to dispatch the input event to the intended view for processing. Typically, the GUI implements a view hierarchy (also often referred to as a “view tree”) of views presently displayed, and representing the parent-child relationships between these views. The dispatch of an input event thus typically involves dispatching the input event down the view hierarchy. In many instances, the positioned event may be intercepted or modified by a parent view of the intended view, such as to account for touch “slop” or to differentiate between different types of gesture inputs, as the input event traverses the view hierarchy.

In a GUI configuration whereby each child view is required to be completely contained within the bounding box of the parent view, the dispatch of view events down a view hierarchy is relatively straightforward in that each parent view receives a positioned event based on the location of the positioned event overlapping the bounding box, or being within the bounds, of the parent view object, and the parent view need only pass an input event to whichever child view object overlaps the positioned event location. However, it may be desirable for aesthetic reasons or other design reasons to provide a view layout in which the positioning of child view objects are not limited by the bounding boxes of their parent view objects. In such instances, the location of the input event intended for a particular view may not fall within the boundary of the parent view object of that particular view. Conventional spatial-based hierarchical event dispatch processes, which constrain a view object to accept only positioned events within the bounding box of the view object, are unable to accurately dispatch and process positioned events in such instances.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram illustrating a process for dispatch of positioned events in an electronic device utilizing an unconstrained GUI in accordance with at least one embodiment of the present disclosure.

FIG. 2 is a block diagram illustrating an example hardware configuration of the electronic device of FIG. 1 in accordance with at least one embodiment of the present disclosure.

FIG. 3 is a flow diagram illustrating a method for positioned event dispatch for an unconstrained GUI in accordance with at least one embodiment of the present disclosure.

FIG. 4 is a diagram illustrating a method for determining a quadtree data structure representing positioning of views of a layout in accordance with at least one embodiment of the present disclosure.

FIG. 5 is a diagram illustrating a method for determining a view map data structure representing positioning of views of a layout in accordance with at least one embodiment of the present disclosure.

FIG. 6 is a diagram illustrating a method for determining a list data structure representing views of a layout in accordance with at least one embodiment of the present disclosure.

### DETAILED DESCRIPTION

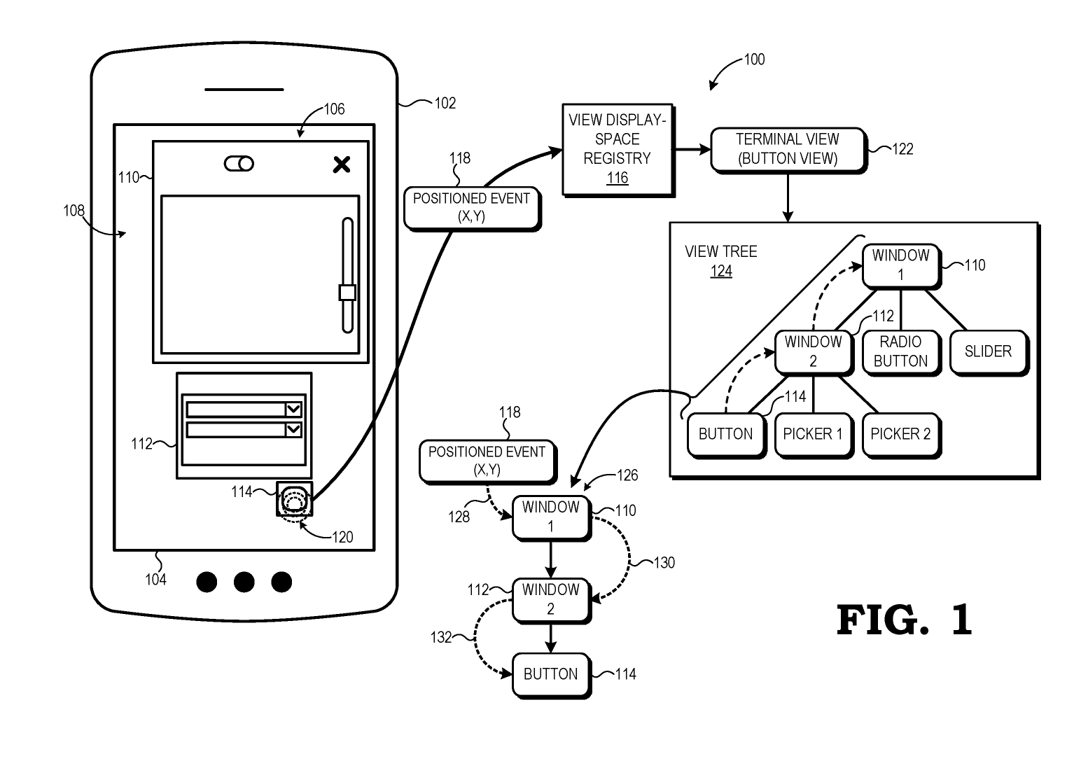

FIGS. 1-6 illustrate example devices and techniques for the processing of positioned input events in an “unconstrained” GUI—that is, a GUI that does not constrain the position of a child view to the bounding box or other boundary of the parent view. An electronic device provides for display of a GUI having a layout of views. A user may utilize a touchscreen, trackpad, mouse, or other positional input component to provide input via the GUI in the form of positioned input events (hereinafter, “positioned events” for brevity) relative to the views in the current layout. The electronic device maintains a view display-space registry in the form of a data structure representative of the views in the current layout and their positions relative to the layout or display space of the display of the electronic device. In response to a positioned event, the electronic device uses the view display-space registry to identify the view for which the positioned event is likely intended—this view being identified herein as the “terminal view.” The electronic device then identifies the location of the terminal view in a view hierarchy for the current layout and works up the view hierarchy from the terminal view to build an ancestor chain representing the chain of views from the top parent view down to the terminal view from the view hierarchy. The electronic device then may sequentially dispatch the positioned event in the ancestor chain until a view in the ancestor chain consumes or modifies the positioned event or the positioned event is ultimately rejected by the terminal view. As part of this dispatch process, filtering of positioned events based on the locations of the positioned events may be disabled or bypassed, thereby allowing each view in the ancestor chain to consider the positioned event regardless of the relationship between the location of the positioned event and a bounding box or other bounds of a non-terminal view.

Through utilization of the view display-space registry to identify a terminal view independent of any parent view, construction of the ancestor chain up from the terminal view, and sequential dispatch of a positioned event down this ancestor chain, an ancestor view may consider the positioned input without having to identify the child view to which the positioned input is to be dispatched. As such, the relationship between the position of the child view and the boundary of the parent view is not germane to the dispatch of the positioned event, which allows a child view to be positioned partially or fully outside the bounds of the parent view while still permitting the expected hierarchical processing of positioned events. That is, as each ancestor view is provided the opportunity to consume, delay, or otherwise modify a positioned event, processing of larger-context user input, such as scrolling, swipe gestures, multi-touch gestures, and the like, continues to be handled appropriately.

For ease of reference, examples and implementations of various aspects are described below with reference to, or in the context of, the Android operating system (OS) framework (hereinafter, “Android framework”) and its corresponding terminology as promulgated by Google Inc. However, these references are exemplary only and are not intended to be limiting. The identified aspects may be similarly implemented in other OS frameworks or user interface (UI) frameworks using the guidelines provided herein.

FIG. 1 illustrates an example process 100 for dispatching positioned events for GUI that does not constrain the position of a child view to the bounding box or other boundary of the parent view (hereinafter, a “constrained GUI”) in accordance with at least one embodiment. The process 100 is performed by an electronic device 102 having a display 104 and one or more positional user input components (not shown in FIG. 1), such as a touch screen, trackpad, mouse, and the like. The electronic device 102 may include, for example, a compute-enabled cellular phone, a tablet computer, a compute-enabled watch or other compute-enabled wearable device, a notebook computer, a desktop computer, a game console, a remote controller, a network appliance, a server computer, a home automation controller, an automotive display interface, a compute-enabled medical device, and the like.

As depicted, the electronic device 102 provides a GUI 106 to a user via the display 104. The GUI 106 includes a layout 108 of views currently displayed in the GUI, such as views 110, 112, 114. For this example, views 110, 112 are window views and view 114 is a button view. Further, view 114 is a child view of view 112, which in turn is a child view of view 110, and thus view 110 is parent to view 112, which in turn is parent to view 114. As also shown by FIG. 1, the GUI 106 is an unconstrained GUI in that the views of the GUI 106 may be at least partially or fully positioned outside of the boundaries of their parent views. To illustrate, view 114 is located entirely outside of the boundary of view 112, and view 112 likewise is located entirely outside of the boundary of view 110. Because of this unconstrained relationship between parent view and child view, a conventional bounding-box-based hierarchical dispatch process would likely fail to appropriately process a positioned event. To illustrate, if the user were to initiate a touch gesture by initiating contact with a touchscreen (not shown) at a location that overlaps the position of the view 112, this location is outside of the boundary of the view 110, and thus when the positioned event corresponding to the initial touchscreen contact is dispatched down a view hierarchy in a conventional spatial-based hierarchical dispatch process, the view 110 would reject the positioned event because the location of the positioned event is outside of the boundary of the view 110.

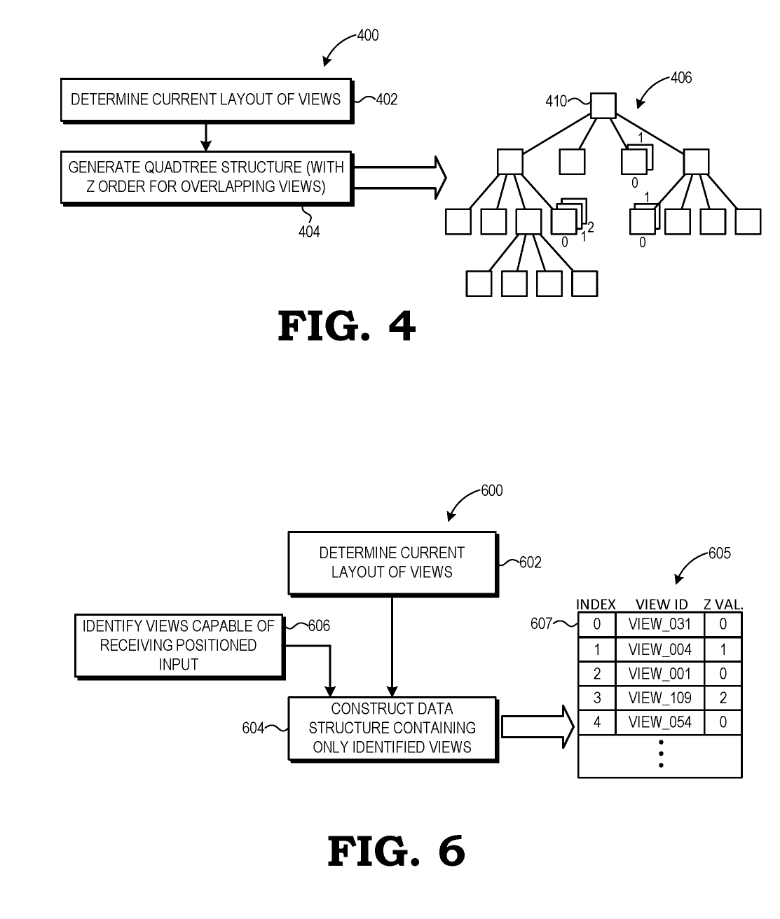

To prevent such boundary-based rejection of positioned events and thus enable the GUI 106 to operate effectively as an unconstrained GUI, the electronic device 102 employs an unconstrained hierarchical dispatch technique (process 100) that operates to dispatch positioned events in a manner that does not rely on bounding-box-based filtering while continuing to enable hierarchical event dispatch for processing of larger-context user input events. To this end, the electronic device 102 maintains a view display-space registry 116 that stores information representing some or all of the views of the current view layout 108 and their positions relative to the layout 108 or to the display space. The view display-space registry 116 may include any of a variety of data structures or combinations of data structures. To illustrate, as described in greater detail below with reference to FIGS. 4-6, the view display-space registry 116 may include a quadtree data structure, a list of views, or an array-based data structure that map or otherwise reference the positions of the associated views to the display space of the display 104. In some embodiments, the view display-space registry 116 represents all views in the layout 108. However, as some views may not be configured to receive user input, or may more particularly, may not be configured to receive position-based input, the electronic device 102 may filter out such views so that only views configured to receive user input, or more specifically, position-based input, are represented in the view display-space registry 116.

In response to the user manipulating a positional input component, the GUI 106 signals an initial positioned event 118, which includes a two-dimensional (2D) location identifier (denoted “(X,Y)”) corresponding to the 2D location in the display space of the display 104 at which the positioned event 118 occurred. For example, this location identifier can identify the position in display space where a user first contacted a touchscreen, the position in display space of a cursor when a mouse button or trackpad button is engaged, and so on. For the following example, it is assumed that this positioned event occurred at a location (denoted in FIG. 1 with the concentric rings of contact point 120) in the display space that overlaps with the location of the button widget of view 114.

The positioned event 118 triggers the electronic device 102 to perform a lookup into, or otherwise access, the view display-space registry 116 to identify the view likely intended by the user to be the target or recipient of the positional event 118. This view is identified herein as the “terminal” view 122 for the positioned event 118. As described in greater detail below, the process of identifying the terminal view 122 generally entails identification of those views of the current layout 108 that have a bounding box overlapping the location (X,Y) of the positioned event 118. It will be appreciated that there may be multiple views that overlap in the layout 108, and thus there may be multiple views that overlap at the location (X,Y). In such instances, the electronic device 102 selects the terminal view 122 from the multiple views based on one or more selection criteria. For example, because the view “on top” in the layout 108 is likely the view intended to receive the user input, the electronic device 102 may utilize the Z number or draw order of each view to select the appropriate view. As another example, if one of the overlapping views is the current “in focus” view, this is a strong hint that the user intended the “in focus” view as the intended view for the user input. For the example of FIG. 1, the positioned event 118 occurs at location (X,Y), which overlaps with a button widget of view 114, and thus view 114 is postulated as the terminal view 122.

Although the electronic device 102 identifies the terminal view 122 using the view display-space registry 116 and thus could dispatch the positioned event 118 directly to the terminal view 122, this would bypass hierarchical dispatch of the positioned event to the ancestor views of the terminal view 122 and thus prevent any larger-context processing of the positioned event 118, including detection of multi-touch gestures, compensation for touch slop, discernment between similar types of gestures (e.g., touch-to-drag vs. touch-to-press gestures). Accordingly, to enable this hierarchical dispatch in the unconstrained GUI 106, the electronic device 102 also identifies those views that are ancestors to the terminal view 122. The underlying operating system (OS) framework or user interface (UI) framework supporting the GUI 106 typically maintains a view tree 124 (or view hierarchy) that both identifies the views present in the current layout 108 and identifies the parent-child relationships between these views.

Accordingly, to identify those views that should have the opportunity to consider the positioned event 118 before it is provided to the terminal view 122, the electronic device 102 identifies the terminal view 122 within the view tree 124 and then sequences up the view tree 124 to identify each ancestor view of the terminal view 122 (assuming the terminal view 122 has at least one ancestor view). The electronic device 102 constructs an ancestor chain 126 that represents the one or more ancestor views of the terminal view 122 and their hierarchical arrangement as determined by the sequencing up the view tree 124 by the electronic device 102. In the example of FIG. 1, view 112 is the parent of view 114 (as terminal view 122) and view 110 is the parent of view 112, and thus the resulting ancestor chain 126 would be: view 110→view 112→view 114.

With the ancestor chain 126 so constructed or otherwise identified, the electronic device 102 then hierarchically dispatches the positioned event 118 sequentially to the views in the ancestor chain 126. Each view may then reject, consume, or modify the dispatched positioned event 118 based on the configuration or programming of the view. In the event that the view has rejected or modified the positioned event 118, the electronic device 102 then may dispatch the rejected/modified positioned event 118 to the next view in the ancestor chain 126. Thus, in the example of FIG. 1, the positioned event 118 is dispatched first to the view 110 (dispatch event 128). In the event that the view 110 does not consume the positioned event 118, the positioned event 118 (or a version thereof as modified by the view 110) may be dispatched next to the view 112 (dispatch event 130). In the event that the view 112 does not consume the positioned event 118, the positioned event 118 (or a version thereof as modified by the view 112) may be dispatched next to the view 114 (dispatch event 132). The view 114, being the terminal view 122, then may elect to consume or reject the positioned event 118 based on the configuration or programming of the view 114.

As noted above, the UI framework supporting the GUI 106 may by default configure a view to reject any positioned event that occurs at a location outside of the bounds of the view. Under this constraint, in the example of FIG. 1 whereby the positioned event 118 occurs at location (X,Y) outside of the bounds of the view 110, the view 110 would otherwise operate to automatically reject the positioned event 118. This could prevent the larger-context positioned event processing, such as slop compensation or scrolling, that otherwise might be provided by the view 110. Accordingly, in implementations with this default bounding-box filtering of positioned events, the electronic device 102 may operate to bypass or disable this filtering so that parent views in the ancestor chain 126 consider the positioned event 118 even though it may have occurred at a location outside of the bounding box of the parent view. This bypass/disabling of spatial filtering may be achieved in any of a variety of ways. For example, the dispatch of the positioned event 118 may occur through a framework that is separate from the default hierarchical dispatch process employed by the GUI 106. As another example, the filtering may be overridden through the setting of a parameter when instantiating a view, the parameter controlling whether bounding-box filtering is to be to be applied for the instance of the view, through a function call that temporarily overrides all bounding box filtering, through use of a special view class that does not use bounding-box filtering, and the like.

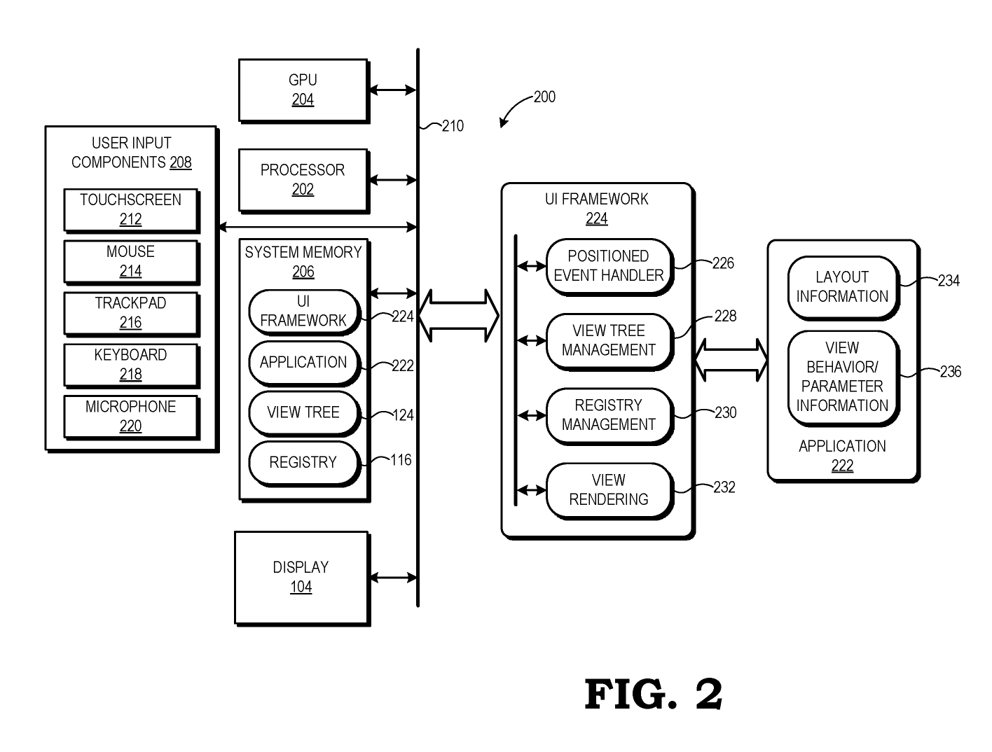

FIG. 2 illustrates an example hardware configuration 200 of the electronic device 102 in accordance with at least one embodiment of the present disclosure. In the depicted example, the electronic device 102 includes one or more processors, such as central processing unit (CPU) 202 and graphics processing unit (GPU) 204, one or more storage components, such as system memory 206 or a storage drive (not shown), a set 208 of user input components, and the display 104 interconnected via one or more busses 210 or other component interconnects. The hardware configuration 200 may further include various other components, such as one or more wireless interfaces, sensors, and the like, which have been omitted from FIG. 2 for purposes of clarity. The set 208 of user input components includes one or more user input components that may be manipulated by a user to perform a UI action, such as a touchscreen 212, a mouse 214, a trackpad 218, a keyboard 218, a microphone 220, and the like. Certain user input components, such as the touchscreen 212, mouse 214, and trackpad 218, may receive input that has a positional aspect relative to the display space of the display 104, and thus are positional input components.

In operation, one or both of the processors 202, 204 execute a software application 222 accessed from the system memory 206 or other storage component. During execution, the software application 222 manipulates the processors 202, 204 and other components of the electronic device 102 to display the GUI 106 (FIG. 1) via the display 104, to receive user input relative to the GUI 106 via one or more of the set 208 of user input components, and to respond to the user input accordingly. To facilitate the operation of the GUI 106 in this manner, the electronic device 102 may provide a user interface (UI) framework 224 that provides the lower-level processing and handling framework for the software application 222 and the GUI 106. To this end, the UI framework 224 may include, for example, a positioned event handler component 226, a view tree management component 228, a registry management component 230, and a view rendering component 232. In some embodiments, the UI framework 224 is part of the operating system (OS) of the electronic device 102, and thus the UI framework 224, as well as the components 226, 228, 230, 232, are implemented as one or both of the processors 202, 204 and one or more sets of executable instructions that are executed by one or both of the processors 202, 204 to provide the functionality described herein. In other embodiments, some or all of the components 226, 228, 230, 232 may be implemented in hardcoded logic, such as in an application specific integrated circuit (ASIC), in programmable logic, such as in a field programmable gate array (FPGA) or programmable logic device (PLD), or a combination thereof.

The view rendering component 232 operates to render the display frames representing the GUI 106 in the current layout 108, and these display frames are then output to the display 104 for display. For this rendering process, the view rendering component 232 references layout information 234 from the software application 222, with the layout information 234 specifying the current views in the layout 108 as well as their relevant display parameters. As part of this rendering process, the view rendering component 232 identifies the Z number or draw order of the views in the current layout and uses the Z numbers/draw order to render the views in accordance with their specified depths, which may result in partial or full occlusion of one or more views in the resulting display frame depending on the depths of the views and degree of overlap with other views.

The view tree management component 228 operates to construct and update the view tree 124 (stored, for example, as one or more data structures in the system memory 206) for the current layout 108. To illustrate, the Android framework provides two classes relating to views: a “View” object that occupies a (typically rectangular) area on the display 104 and is responsible for drawing and event handling; and a “ViewGroup” object which is a special view that can contain other views. Using this classification scheme, a UI may designate leaf child views as “View” objects (e.g., view 114 with a “Button” widget”), and parent views as “ViewGroup” objects (e.g., views 110, 110). Thus, while the software application 222 is executing, the underlying Android OS (one embodiment of the UI framework 224) may process the current layout 108 on display, identify the instantiated View objects and ViewGroup objects in the current layout 108 and their parent/child relationship, and build the view tree 124 based on this identified information.

The registry management component 230 operates to construct and maintain the view display-space registry 116, which may be stored as one or more data structures in the system memory 206 or other storage component of the electronic device 102. The registry management component 230 may utilize the view tree 124 to identify the views in the current layout 108, and in some implementations the positions of the views, and update the view display-space registry 116 accordingly. The view rendering component 232 may utilize a rendering tree to identify the views to be rendered, and thus the registry management component 230 alternatively may use this rendering tree in identifying the views in the current layout 108, as well as their positions relative to display space. The representation of a particular view in the view display-space registry 116 may be based on information pertaining to that view as provided by the software application 222 (this information being identified herein as “view behavior/parameter information 236”). To illustrate, the view behavior/parameter information 236 may identify size and position parameters for the view, and thus indicating the position of the view in the display space coordinates, which in turn may be reflected in some form in the view display-space registry 116. As another example, the view behavior/parameter information 236 may indicate the class or type of the view, and from this the registry management component 230 may determine whether the view is configured to accept position-based user input. If not, the registry management component 230 may then filter out the view so as to prevent its unnecessary inclusion in the view display-space registry 116.

The positioned event handler component 226 operates to detect positioned events from user manipulation of the positional user input components and then hierarchically dispatch these positioned events among the views of the current layout 108 using the techniques described herein. To this end, the positioned event handler component 226 coordinates with the other components 228, 230, 232 of the UI framework 224 in identifying the terminal view intended for a positioned event, traversing the view tree 124 to construct the ancestor chain 126, and sequentially dispatching the positioned event through one or more views of the ancestor chain 126.

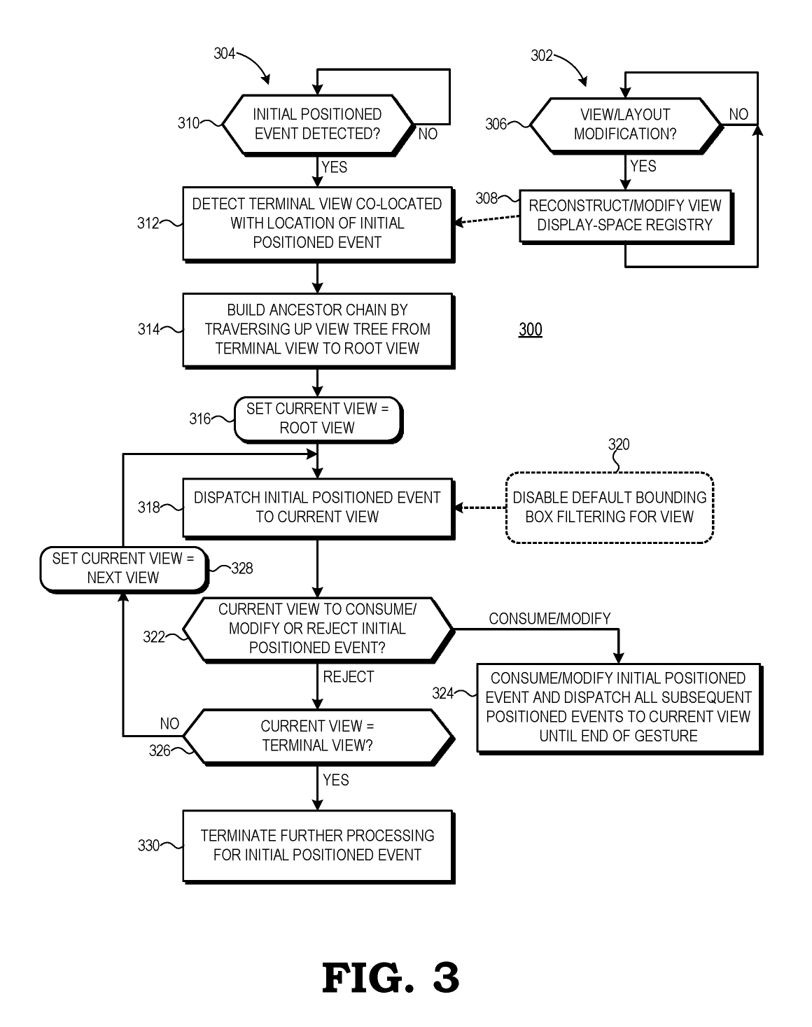

The operations of the components 226, 228, 230, 232 and the other components of the hardware configuration 200 of the electronic device 102 may be more fully understood with reference to FIG. 3, which illustrates a method 300 for hierarchical dispatch in an unconstrained GUI in accordance with at least one embodiment. Although method 300 is described in the example context of the hardware configuration 200 of FIG. 2, it should be appreciated that the method 300 may be similarly employed in other hardware configurations of an electronic device using the guidelines provided herein. Further, while method 300 illustrates events in a particular sequence, it should be appreciated that these events may be performed in another order as appropriate, or that some events may be omitted. The method 300 reflects two processes operating in parallel: a process of updating the layout 108 of the GUI 106, as represented by flow 302; and a process of hierarchical dispatch of a positioned event based on the current layout 108, as represented by flow 304.

Turning first to flow 302, at block 306 the UI framework 224 monitors for user input or other stimuli that triggers an update to the layout 108 of the GUI 106. For example, the user may utilize a user input component to “drag” a view to a new location, to close a view, to open a view, or otherwise provide input that modifies the appearance or existence of a view. Alternatively, underlying processes occurring during execution of the software application 222 or during execution of the OS may trigger a change in the position, existence, or appearance of one or more views. In such an event, the UI framework 224 reconstructs or otherwise modifies the layout 108 accordingly, and the view rendering component 232 renders display frames representative of the current layout 108. Further, the view tree management component 228 updates the view tree 124 as appropriate to reflect the view hierarchy of the views in the current layout 108. Further in response to this change in the layout 108, at block 308 the registry management component 230 updates the view display-space registry 116 to reflect views in the currently layout 108 and, in some implementations, the current positions of these views with respect to the display space coordinate frame.

Flow 304 initiates at block 310, whereby the positioned event handler component 226 monitors for user manipulation of a positional user input component that signals the start of a gesture or other positional user input. To illustrate, upon detection of an initial touch event to the touchscreen 212 indicating the start of a touch gesture, an Android-based implementation of the UI framework 224 would instantiate a touch event of the class “MotionEvent” and assign this initial touch event the action code ACTION_DOWN and a set of axis values that include the X and Y coordinates of the touch event relative to the touchscreen 212, along with a base pointer value (e.g., 0). For each subsequent touch event until the user has completed or canceled the touch gesture, the UI framework 224 would instantiate another touch event, assign the appropriate action code (e.g., ACTION_MOVE) and corresponding set of axis values, and an incremented pointer value. The last touch event for the gesture would be assigned an action code ACTION_UP (or ACTION_CANCELED if the user cancels the gesture action). Similar actions may be taken for mouse-based gestures or trackpad-based gestures.

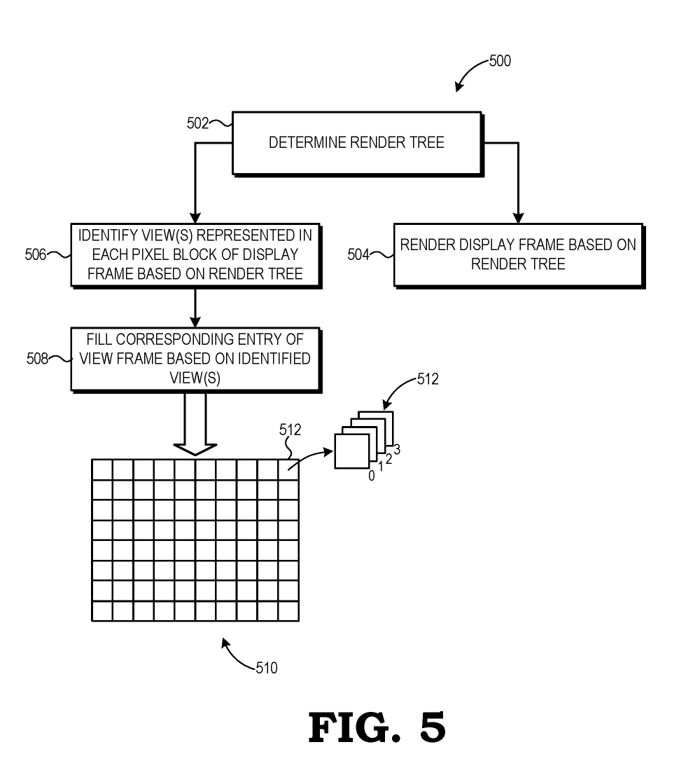

In the event that the UI framework 224 signals an initial positioned event (e.g., a MotionEvent with action code=ACTION_DOWN), at block 312 the registry management component 230 queries the view display-space registry 116 to identify the terminal view (e.g., terminal view 122) likely intended for receipt of the positional user input. In some embodiments, the view display-space registry 116 registers views on the basis of their positions relative to the display space or otherwise includes reference to the positions of the views, and thus the registry management component 230 may identify the terminal view through application of a hit testing using the X,Y coordinates of the initial positioned event detected at block 310. To illustrate, as described below with reference to FIG. 4, the views of the current layout 108 may be maintained in the view display-space registry 116 based on a quadtree representation of the display space and the positions of the views therein, and thus the hit test may take the form of a traversal of the quadtree based on the X,Y coordinates. As described below with reference to FIG. 5, the view display-space registry 116 may take the form of a view map built as a 2D array of entries, each entry associated with a corresponding pixel block of one or more pixels of the display space and storing an indication of any view(s) positioned in the corresponding pixel block. In this case, the hit testing may take the form of indexing the appropriate entry based on the X,Y coordinates of the input positioned event, identifying the views (if any) represented in the entry, and if there are more than one view so represented, selecting the terminal view from the multiple represented views based on, for example, the Z numbers or draw order of the views. Alternatively, as described below with reference to FIG. 6, the view display-space registry 116 may take the form of a list of views and a representation of their positions relative to the display space, the hit testing make take the form of some form of search through the list based on comparisons of the representations of the listed view's positions and the X,Y coordinates.

With the terminal view identified, at block 314 the view tree management component 228 locates the terminal view within the view tree 124 and then traverses up the view tree 124 to identify the ancestor chain (e.g., ancestor chain 126) of the terminal view. In the Android framework, the parent view of a given view may be invoked by calling the function View#getParent( ) for that view. Thus, the view tree management component 228 may traverse up the view tree 124 by calling getParent( ) for the terminal view to identify the immediate parent view for the terminal view, then calling getParent( ) for this parent view to identify the parent view at the next higher level, and so on until the call to getParent( ) returns a null value, thereby indicating that the current view is the root parent view for the terminal view. As each view is identified as an ancestor, the view tree management component 228 adds an identifier of the view (e.g., the identifier assigned to the view in the Android framework) to the ancestor chain. The ancestor chain thus may be constructed as, for example, a linked list with both forward and backward pointers, thereby allowing the positioned event handler component 226 to traverse from root view (with reference to the current view layout) to the terminal view.

With the ancestor chain constructed, the positioned event handler component 226 initiates the hierarchical dispatch of the initial positioned event through the ancestor chain. At block 316, the positioned event handler component 226 initially sets the current view to the identifier of the root view in the ancestor chain. At block 318, the positioned event handler component 226 dispatches the initial positioned event to the current view, which in the first iteration of block 318 is the root view of the ancestor chain. As explained above, the UI framework 224 may, by default, employ bounding-box-based filtering for dispatch events whereby a view may be configured to automatically reject any positioned event having a location that is outside of the bounding box of the view. Accordingly, at block 320 the UI framework 224 may take action to disable or bypass this filtering. For example, in the Android framework, the function call View#isTransformedTouchPointInView( ) returns a Boolean value indicating whether a location (x,y) supplied with the function call is within the bounding box or other bounds of the corresponding view, and the basis of the default filtering of positioned events is based on whether this function call returns a True or False value. Accordingly, for views identified at build time or compile time to be views that do not spatially constrain their child views, the library for this function call, or the compilation of this function call, may be configured for such views to either be disabled or to always return a value of True, thereby overriding the default operation of this function call. Alternatively, for such views, the spatial check using the function call View#isTransformedTouchPointInView( ) may be replaced manually during development of the software application 222 or during build/compilation to include a directed dispatch to a single child view known at that time.

At block 322, the current view to which the initial positioned event has been dispatched processes the initial positioned event to determine whether the positioned event should be rejected, consumed, or modified by the current view. In the event that the current view is an ancestor of the terminal view, this processing can include evaluation of the initial positioned event for higher-level gesture context, such as for purposes of handling touch event slop or scrolling events. In the event that the current view elects to consume or modify the initial positioned event, at block 324 the initial positioned event is consumed or modified by the current view. Further, in the event that the positioned event is modified, the modified positioned event is then dispatched down the ancestor chain in the same manner as the unmodified initial positioned event would otherwise be dispatched down the ancestor chain. Further, in the Android framework and other UI frameworks, after a view has elected to consume or modify a positioned event in a sequence of positioned events representing a user input gesture, all subsequent positioned events in that sequence are by default intercepted by, or dispatched directly to, that view. In keeping with this configuration, in at least one embodiment, if the current view consumes or modifies the initial positioned event, then all subsequent positioned events are dispatched or intercepted by the current view until the gesture is completed or canceled.

Returning to block 322, in the event that the current view rejects the initial positioned event, the hierarchical dispatch process moves on to the next view in the ancestor chain. Accordingly, to verify that there is a next view in the ancestor chain, at block 326 the positioned event handler component 226 checks whether the current view is the terminal view of the ancestor chain. If not, at block 328 the positioned event handler component 226 sets the current view to the next view of the ancestor chain, and the process of blocks 318, 320, 322, 324, and 326 is repeated for this next view as the current view. Otherwise, if the current view that rejected the initial positioned event is the terminal view, then the UI framework 224 may conclude that the user input was spurious or in error, and thus terminate any further processing of the initial positioned event at block 330.

As explained above, the view display-space registry 116 is implemented as one or more data structures used to store information identifying the views of the current layout 108, and this information is used to identify the terminal view associated with the position of a positioned event. Although the view display-space registry 116 may take any of a variety of forms in accordance with the guidelines provided herein, FIGS. 4-6 illustrate methods for constructing and maintaining certain example data structures for the view display-space registry 116.

FIG. 4 depicts an example method 400 for constructing and maintaining the view display-space registry 116 in the form of a quadtree data structure. The method 400 initiates at block 402, whereby the registry management component 230 utilizes the information from the current layout 108 to identify the views in the current layout and uses positional information obtained for the identified views to determine the positions within the display space.

With the views and their positions relative to the display space so identified, at block 404 the registry management component 230 constructs a quadtree data structure 406 that represents the views and their identified positions. In this process, the top node 408 of the quadtree data structure 406 represents the display space. The display space is spatially separated into four quadrants, which are represented by the four nodes immediately under node 408. Any quadrant having a view positioned therein is then itself partitioned into four sub-quadrants, each represented by a corresponding node. This process is recursively repeated for a specified number of levels of the quad tree, or until no further divisions of a sub-quadrant are necessary. In the quadtree data structure 406, all terminal leaf nodes either contain entries for one or more views that overlap the corresponding sub-quadrant of the display space, or are null, or empty leaf nodes. As the layout 108 may accommodate views of different depths, and thus some views may partially or fully occlude other views in the layout 108, there may be multiple views that overlap a given sub-quadrant, and thus the terminal leaf node for that sub-quadrant may have multiple entries, one for each view present in that sub-quadrant. These entries may store an identifier (ID) of the corresponding view, as well as an identifier of the depth of the view, such as the view's Z value or draw order (e.g., as represented by the numbers “0”, “1”, and “2” in the quadtree data structure 406).

Thus, to perform a hit test on the quadtree data structure 406, the registry management component 230 traverses the quadtree to find the terminal leaf node that represents the sub-quadrant containing the (X,Y) location of the positioned event. In the event that this terminal leaf node is a null node, the hit test fails and the UI framework 224 ceases processing of the positioned event. In the event that there is a single entry at the terminal leaf node, the registry management component 230 returns the view ID stored at this single entry as the terminal view overlapping the location of the positioned event. In the event that there are multiple entries representing multiple overlapping views at the positioned event location, the registry management component 230 may select, for example, the view having the highest Z value (that is, the least-deep view) as the terminal view, and thus return the view ID of this view as the terminal view.

FIG. 5 depicts a method 500 for constructing and maintaining the view display-space registry 116 as a pixel-block-based array of entries in accordance with some embodiments. As noted above, the view rendering component 232 may generate one or more display frames representative of the display view of the current layout 108, where the display frames represent the display-space view of the current layout 108, including occlusion of deeper (higher-Z) views that are overlapped by shallower (lower-Z) views. The view rendering component 232 may utilize a rendering tree that identifies each view that is to be visible in the display frame to be rendered, as well as its layout within the display space. As a user input is less likely to be directed to a view that is not visible or largely occluded, this rendering tree may serve as an efficient representation of the views of interest, and their positions, for the current layout 108. Accordingly, the method 500 initiates at block 502 with the view rendering component 232 determining or accessing a render tree for the current layout 108. At block 504, the view rendering component 232 renders a display frame based on the rendering tree.

The rendered display frame includes a 2D array of pixels, which the registry management component 230 may logically partition into a set of pixel blocks, with each pixel block including one or more pixels of this 2D array of pixels. To illustrate, the display frame may be logically partitioned into an array of pixel blocks of 4×4, 8×8, or 16×16 pixels. The registry management component 230 also constructs a view map 510 including a 2D array of entries 512, with each entry 512 associated with a corresponding pixel block. With this, at block 506, the registry management component 230 uses the rendering tree to identify, for each pixel block, whether any of the views of the current layout overlap the location of the pixel block. At block 508, the registry management component 230 fills the entry associated with each pixel block with information identifying any views determined to overlap the corresponding pixel block. In the event that there are multiple views overlapping a given pixel block, the entry 512 corresponding to that pixel block may be subdivided into multiple sub-entries, with each sub-entry storing the ID of a corresponding view. Each subentry may also include the Z-number or draw order of the view, or the sub-entries may be organized according to Z-number or draw order.

Due to the highly parallelized nature of the determination of the views overlapping each pixel block, the method 500 may be advantageously implemented by the GPU 204. Moreover, in view of the tight correlation between the rendering of the pixel blocks of the display frame and the construction of view map 510 based on these pixel blocks, in some embodiments the method 500 may be performed as part of the display frame rendering process, with each vector unit of the GPU 204 performing both the rendering process for the corresponding pixel block as well as the overlapping view identification process for the same pixel block.

As the view map 510 maps views to each and every pixel block overlapped by the view in the display space, the registry management component 230 may perform a hit test using the view map 510 to identify the terminal view associated with a positioned event at location (X,Y) relative to the display space by identifying the pixel block located at the coordinates (X,Y), identifying the entry 512 associated with that pixel block. In the event that the identified entry 512 is empty, then the registry management component 230 returns a null value, and the dispatch process terminates. In the event that the entry 512 identifies a single view, the view ID of this single view is returned by the registry management component 230 as the terminal view. In the event that the entry 512 identifies multiple views, the view ID of the view having the lowest Z value/draw order may be returned as the terminal view.

The implementation of the view display-space registry 116 as a quadtree data structure as shown in FIG. 4, a 2D pixel-block-based view map as shown in FIG. 5, or other spatial-based organization of views may be impracticable from due to performance, storage, or power limitations. Accordingly, FIG. 6 illustrates a method 600 for constructing an implementation of the view display-space registry 116 as a list-based data structure in accordance with at least one embodiment. The method 600 initiates at block 602, wherein the registry management component 230 utilizes the information from the current layout 108 to identify the views in the current layout and their corresponding positional information. At block 604, the registry management component 230 generates a view list 605 based on the identified views. As shown, the view list 605 contains a list of entries 607, each entry 607 representing a corresponding view and having one or more fields, such as an index field storing an index value for the entry, a view ID field storing a view ID of the view represented by the entry 607, and a depth field storing the Z value or draw order value for the view.

Depending on the particular configuration of the GUI 106, some of the views in the current layout 108 may not be configured to receive positional user input, and thus cannot consume or modify a positioned event triggered by positional user input. As such, during the construction of the view list 605 at block 604, the registry management component 230 may identify those views of the current layout 108 that are not configured to receive positional user input and filter out such views so that the view list 605 contains entries 607 only for views identified as capable of receiving positional user input or as having an indeterminate capability with regard to receiving positional user input, as represented by block 606. However, in implementations where only a relatively small number of views in any given layout are anticipated, this filtering process may be omitted.

As illustrated by block 608, the registry management component 230 may perform a hit test to identify the terminal view for a positioned event by searching through the view list 605 to identify a listed view that has a position that overlaps with the location of the positioned event. To this end, the position of each view may be determined at the point of generation of the corresponding entry 607 and included in a corresponding position field (not shown) of the entry 607. Alternatively, the position of a view under consideration may be determined by utilizing one or more function calls that return dimensional or positional information for the view. The search of the view list 605 utilize any of a variety of search methodologies. For example, the search may include a straightforward sequential search starting at the first entry in the list, then on to the second entry in the list, and so forth. Alternatively, the view list 605 may be at least rudimentarily sorted by some parameter, such as by Z-number, overall view size, etc., and the search may leverage this sorting, such as by sorting the entries based on corresponding Z-number and then performing a prioritized search based on Z-number order.

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any property(s) that may cause any benefit, advantage, or solution to occur or become more pronounced are not to be construed as a critical, required, or essential property of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. In an electronic device, a method comprising:
displaying, at a display of the electronic device, a layout of views; and
in response to detecting, via a user input component of the electronic device, a positioned event in association with the layout:
identifying a terminal view of the layout of views based on a location of the positioned event;
constructing an ancestor chain of one or more ancestor views of the terminal view from the layout; and
sequentially dispatching the positioned event in the ancestor chain starting at a root view of the ancestor chain.

2. The method of claim 1, wherein:
displaying the layout of views includes:
displaying a first view having a bounding box; and
displaying a second view at least partially outside the bounding box, the second view including a child view of the first view;
identifying the terminal view of the layout includes identifying the second view as the terminal view;
constructing the ancestor chain includes identifying the first view as the ancestor of the second view in the ancestor chain; and
sequentially dispatching the positioned event includes dispatching the positioned event to the first view prior to dispatching the positioned event to the second view.

3. The method of claim 2, wherein:
sequentially dispatching the positioned event to the first view includes disabling or bypassing bounding-box-based filtering of positioned events by the first view.

4. The method of claim 1, wherein:
sequentially dispatching the positioned event in the ancestor chain includes dispatching the positioned event to each view in sequence through the ancestor chain until either a view of the ancestor chain consumes or modifies the positioned event or the terminal view rejects the positioned event.

5. The method of claim 4, wherein:
the positioned event is an initial positioned event of a sequence of positioned events representing a gesture performed by a user; and
the method further includes:
dispatching other positioned events of the sequence to a view of the ancestor chain that consumed or modified the initial positioned event.

6. The method of claim 1, further comprising:
providing a data structure that maps each view of the layout to one or more corresponding positions in a display space associated with the layout; and
wherein identifying the terminal view includes identifying the terminal view based on a lookup into the data structure using the location of the positioned event.

7. The method of claim 6, wherein providing the data structure comprises:
providing the data structure as two-dimensional array of entries, each entry of the array associated with a corresponding pixel block of a display space of the display and including one or more sub-entries, each sub-entry configured to store an identifier of a corresponding view having a position that overlaps with the pixel block in the display space.

8. The method of claim 7, wherein identifying the terminal view comprises:
identifying the entry of the array associated with the pixel block located at the position of the positioned event; and
selecting as the terminal view the view represented by the sub-entry that represents the lowest draw order of all views represented by sub-entries of the identified entry.

9. The method of claim 1, further comprising:
identifying which views of the layout of views are configured to consume or modify positioned events;
providing a data structure including a list of the identified views; and
wherein identifying the terminal view includes performing hit testing using the location of the positioned event and positions for the views in the list of identified views.

10. An electronic device comprising:
a display to display a layout of views;
a user input component to receive input representative of a positioned event;
a positioned event handler component to detect the positioned event;
a registry management component to identify a terminal view of the layout of views based on a location of the positioned event;
a view tree management component to construct an ancestor chain of one or more ancestor views of the terminal view from the layout; and
wherein the positioned event handler component is to sequentially dispatch the positioned event in the ancestor chain starting at a root view of the ancestor chain.

11. The electronic device of claim 10, wherein the layout comprises:
a first view having a bounding box; and
a second view at least partially outside the bounding box, the second view including a child view of the first view.

12. The electronic device of claim 11, wherein:
the positioned event handler component is to disable or bypass bounding-box-based filtering of positioned events by the first view.

13. The electronic device of claim 10, wherein the positioned event handler component is to sequentially dispatch the positioned event by:
dispatching the positioned event to each view in sequence through the ancestor chain until either a view of the ancestor chain consumes or modifies the positioned event or the terminal view rejects the positioned event.

14. The electronic device of claim 13, wherein:
the positioned event is an initial positioned event of a sequence of positioned events representing a gesture performed by a user;
the initial positioned event is consumed or modified by a view of the ancestor chain; and
the positioned event handler component is to dispatch the remaining positioned events of the sequence of positioned events to the view that consumed or modified the initial positioned event.

15. The electronic device of claim 10, wherein:
the registry management component is to provide a data structure that maps each view of the layout to one or more corresponding positions in a display space associated with the layout; and
the registry management component is to identify the terminal view by identifying the terminal view based on a lookup into the data structure using the location of the positioned event.

16. The electronic device of claim 15, wherein:
the data structure includes a quadtree data structure.

17. The electronic device of claim 15, wherein:
the data structure includes a two-dimensional array of entries, each entry of the array associated with a corresponding pixel block of a display space of the display and includes one or more sub-entries, each sub-entry configured to store an identifier of a corresponding view having a position that overlaps with the pixel block in the display space.

18. In an electronic device, a method comprising:
providing a data structure representing positions of views of a layout of views at a display of the electronic device;
identifying a first terminal view overlapping a location of a first positioned event at the electronic device based on the data structure, the first terminal view positioned at least partially outside of a bounding box of a parent view of the first terminal view; and
dispatching the first positioned event through a first chain of views including the first terminal view and the parent view of the first terminal view.

19. The method of claim 18, further comprising:
responsive to a change in the layout of views at the display, updating the data structure to represent positions of views in the changed layout;
identifying a second terminal view overlapping a position of a second positioned event at the electronic device based on the updated data structure, the second terminal view positioned at least partially outside of a bounding box of a parent view of the second terminal view; and
dispatching the second positioned event through a second chain of views including the second terminal view and the parent view of the second terminal view.

20. The method of claim 18, wherein:
the data structure includes at least one of:
a quadtree data structure;
a list of the views of the layout; and
a two-dimensional array of entries, each entry of the array associated with a corresponding pixel block of a display space of the display and includes one or more sub-entries, each sub-entry configured to store an identifier of a corresponding view having a position that overlaps with the pixel block in the display space.
